(19) United States
(12) Patent Application Publication
(10) Pub. No.: US 2005/0119054 A1
(43) Pub. Date: Jun. 2, 2005

(54) Gaming machine

(75) Inventors: Takashi Izawa, Tokyo (JP); Tetsuya Yokota, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 10/965,776

(22) Filed: Oct. 18, 2004

(30) Foreign Application Priority Data
Oct. 21, 2003 (JP) P2003-361168
Mar. 9, 2004 (JP) P2004-066043
Mar. 9, 2004 (JP) P2004-066044

(51) Int. Cl. A63F 13/00

(52) U.S. Cl. 463/46

(57) ABSTRACT

A gaming machine of the present invention includes a cabinet, a gaming unit required for playing a game housed in the cabinet, an open/close door capable of closing a housing part for the gaming unit, and operation units each including an operation part where a player performs operation required for playing the game. The open/close door is formed in a shape having a fixed end portion fixed to the cabinet and a plurality of free end portions not fixed to the cabinet, and the operation units are placed at positions where the operation units are capable of abutting on the free end portions of the open/close door.

### CROSS REFERENCE TO RELATED A IONS

This application is based upon and claims the benefit of priority from the prior Japanese Patent Application No. 2003-361168, filed on Oct. 21, 2003; 2004-066043, filed on Mar. 9, 2004; 2004-066044, filed on Mar. 9, 2004 the entire contents of which are incorporated herein by reference.

### BACKGROUND OF THE INVENTION

1. Field of the Invention

The present invention relates to a gaming machine on which a player can play various kinds of games.

2. Related Background Art

Conventionally, a variety of gaming machines on which various games can be played have been known. Examples of a slot machine that is known as one kind of the gaming machines include well-known two types as follows: one is a slot machine having a variable display device in which a plurality of mechanical reels each for displaying a plurality of symbols are arranged (also referred to as a reel unit); and the other is a slot machine having an image display device for displaying variable display images of a plurality of symbols as if mechanical reels are rotating (a so-called video slot machine). In addition, in the former type of slot machine, an image display device for mainly displaying a performance image may be placed on the front face of the mechanical reels.

On the other hand, in a conventional gaming machine, a device required for playing games (hereinafter, referred to as a “gaming unit”) such as a variable display device or an image display device is incorporated in a cabinet. Depending on the difference in structure of the cabinet, gaming machines are classified into a type on which a player plays a game while sitting (a so-called slant-type, see, for example, Japanese Patent Application Laid-open No. 2003-67810: Patent Document 1) and a type on which a player plays a game while standing (a so-called upright-type, see, for example, Japanese Patent Application Laid-open No. 2001-198265: Patent Document 2).

In both the slant-type and upright-type gaming machines, a visible part for the player to view the gaming unit and a plurality of operation parts where the player performs operation required for playing the game, are provided in the cabinet. The operation parts include, for example, operation buttons with which the player performs various kinds of input operation, a coin slot for throwing coins thereinto, an input device such as a touch panel or the like for inputting information according to a place where a finger touches, a card reader for reading information stored in a card, and so on.

### SUMMARY OF THE INVENTION

Incidentally, in a conventional gaming machine, the visible part may have an openable/closable structure by means of a door which is freely opened/closed (an open/close door), so that when this open/close door is opened, a housing part for the gaming unit appears so that the gaming unit can be taken in/out. The open/close door is openably/closably fixed to the cabinet by, for example, a hinge mechanism so that when the open/close door is turned in a specific direction (for example, upward) from a closed position (in a normal gaming state) where it closes the housing part, the housing part appears.

However, in the conventional gaming machine, when the door is opened, a part of the operation parts might be hidden under the open/close door. This makes it difficult to perform operation and visual check of a part of the operation parts during maintenance of the gaming unit housed in the cabinet, presenting a problem that the maintenance of the gaming unit becomes troublesome.

Besides, in a conventional gaming machine, a part or all of the operation parts may be detachably mounted on the cabinet with screws or the like mainly for the purpose of maintenance. In this case, the operation part needs to be detached from the cabinet by loosening the screws and mounted to the cabinet by tightening the screws at each time of maintenance. Therefore, detachment and attachment work of the conventional gaming machine is very troublesome, presenting another problem that maintenance of the operation parts is also very troublesome.

The present invention has been developed to solve the above problems, and its object is to improve the maintenance property of a gaming unit and operation parts in a gaming machine including the gaming unit and the operation parts so that the maintenance work can be easily carried out.

To achieve the above object, the present invention is a gaming machine including a cabinet, a gaming unit required for playing a game housed in the cabinet, an open/close door capable of closing a housing part for the gaming unit in the cabinet, and operation units each including an operation part where a player performs operation required for playing the game, which is characterized in that the open/close door is formed in a shape having a fixed end portion fixed to the cabinet and a plurality of free end portions not fixed to the cabinet, and that the operation units are placed at positions where the operation units are capable of abutting on the free end portions of the open/close door.

In this gaming machine, since the operation units are placed at positions where the operation units are capable of abutting on the free end portions of the open/close door, the operation units never hinder the open/close door in opening/closing.

Further, it is possible that, in the above-described gaming machine, the operation units are placed at positions opposite each other across the housing part.

In this configuration, the operation units are placed at positions opposite each other across the open/close door.

Furthermore, it is suitable that the operation unit has a projecting end portion capable of coming into contact with a backside of the free end portion of the open/close door so that when the open/close door closes the housing part, the backside of the free end portion of the open/close door overlies the projecting end portion.

In this case, when the open/close door closes the housing part, the backside of the free end portion of the open/close door overlies the projecting end portion, so that the open/close door can retain the operation unit.

It is also possible that in the above-described gaming machine, the operation units have a configuration attachable to/detachable from the cabinet, and the above-described gaming machine further includes a positioning means for positioning the operation units with respect to the cabinet. This enables positioning when the operation units are attached to the cabinet.

In this case, it is possible that the positioning means is composed of a projection-shaped structure portion provided on any one of the operation unit and the cabinet and a recess-shaped structure portion provided on the other capable of recess-projection fitting over the projection-shaped structure portion.

Further, it is also preferable that the gaming machine further has a configuration that an open angle of the open/close door from a closed state thereof is settable to 90 degrees or more.

Furthermore, it is preferable to further include a support means for openably/closably supporting the open/close door and capable maintaining an open state of the open/close door. This allows the open state that the open/close door is kept opened to be maintained.

Further, the present invention provides a gaming machine including a cabinet, a gaming unit required for playing a game housed in the cabinet, a rectangular open/close door capable of closing a housing part for the gaming unit in the cabinet, and a plurality of operation units each including an operation part where a player performs operation required for playing the game, wherein the operation units are placed at positions opposite each other along a direction crossing a direction of movement of the open/close door and where the operation units are capable of abutting on any of the end portions of the open/close door.

In this gaming machine, the operation units are placed at position where they never hinder the open/close door in moving.

The present invention will be more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a perspective view showing the entire configuration of a slot machine according to an embodiment of the present invention;

FIG. 2 is an enlarged perspective view of a principal part showing a state in which an open/close door of the slot machine is opened;

FIG. 3 is an exploded perspective view showing a state in which the open/close door is opened and a base portion and a card reader are detached;

FIG. 4 is an enlarged side view of the principal part showing a state in which the open/close door of the slot machine is opened;

FIG. 5 is a side view schematically showing a detachment restrained state of the base portion and the card reader by closing the open/close door;

FIG. 6 is a perspective view showing the entire configuration of another slot machine;

FIG. 7 is an enlarged perspective view of a principal part showing a state in which an open/close door of a slot machine according to a second embodiment is opened;

FIG. 8 is a back view of a base portion in the slot machine according to the second embodiment;

FIG. 9 is a perspective view showing an inner portion where the base portion of the cabinet in the slot machine according to the second embodiment is placed; and

FIG. 10 is an enlarged perspective view of the principal part showing a state in which the open/close door of the slot machine according to the second embodiment is opened to 90 degrees or more.

### DESCRIPTION OF THE PREFERRED EMBODIMENTS

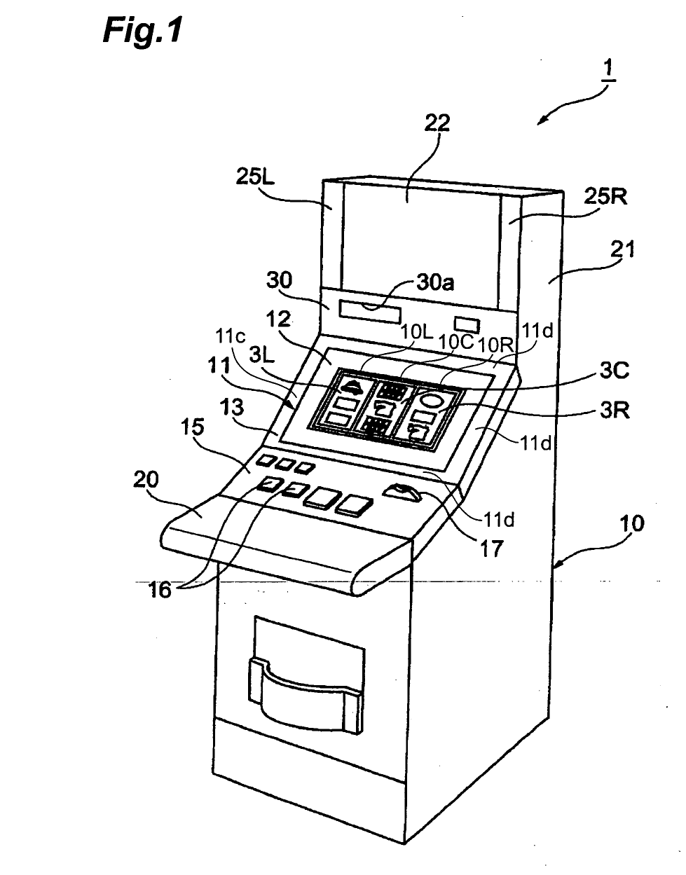

Preferred embodiments of a gaming machine according to the present invention will be described below in detail with reference to FIG. 1 to FIG. 10 taking a slant-type slot machine as an example. Note that the same reference numbers are used for the same components and overlapping description thereof is omitted.

### First Embodiment

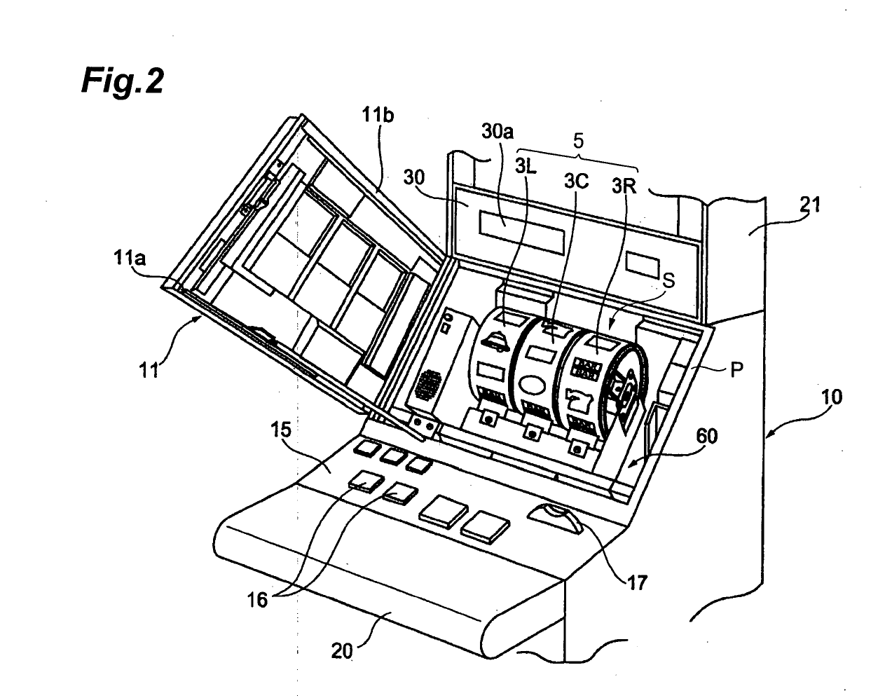

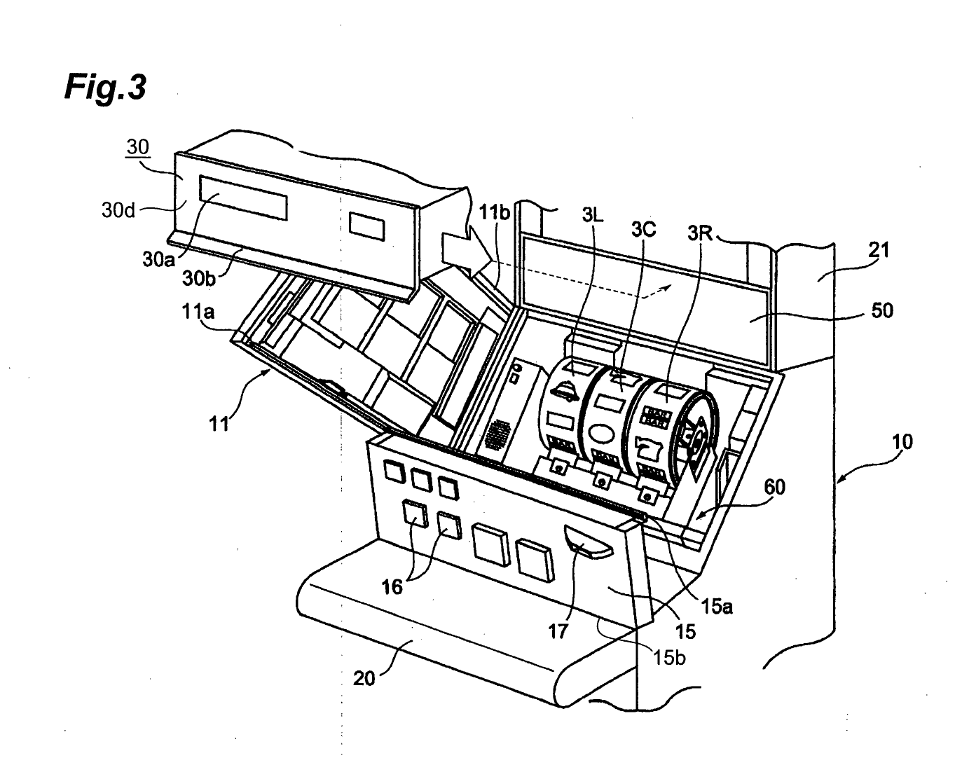

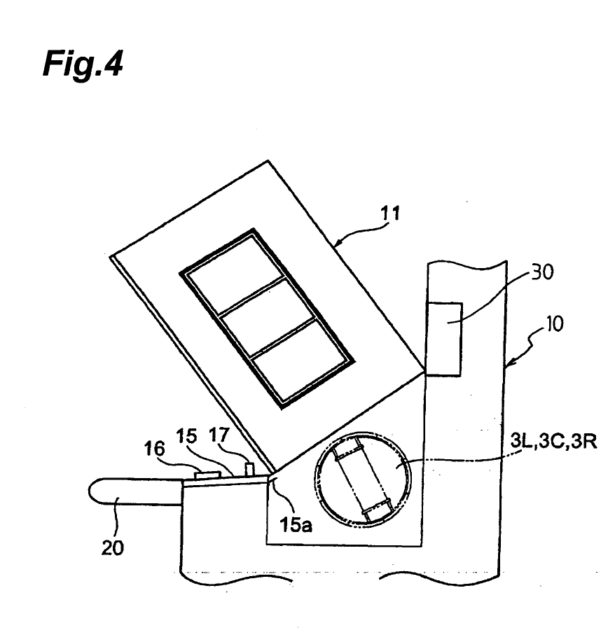

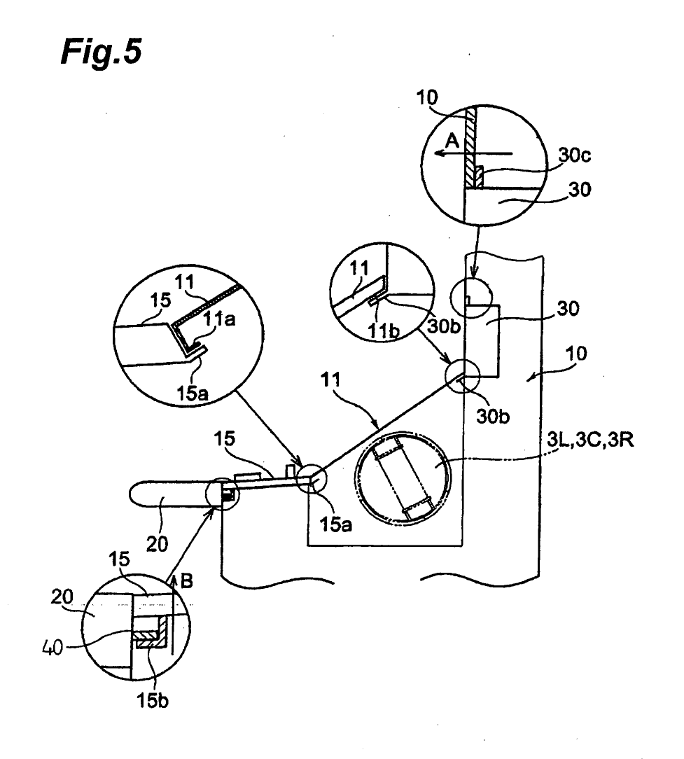

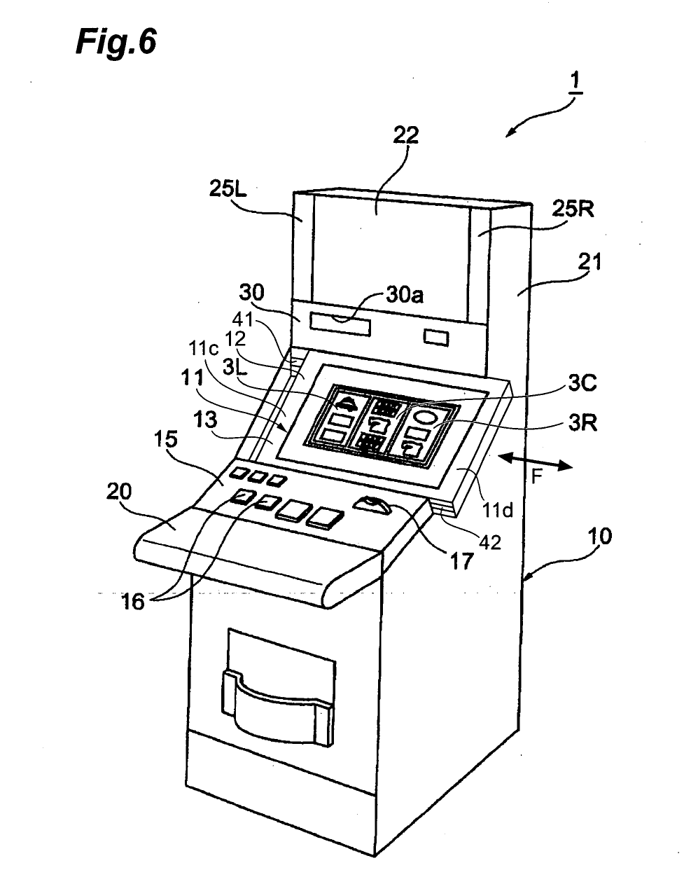

FIG. 1 is a perspective view showing the entire configuration of a slot machine 1 according to an embodiment of the present invention, and FIG. 2 is an enlarged perspective view of a principal part showing a state in which an open/close door 11 of the slot machine 1 is opened. FIG. 3 is an exploded perspective view showing a state in which the open/close door is opened and a base portion and a card reader are detached, and FIG. 4 is an enlarged side view of the principal part showing a state in which the open/close door 11 of the slot machine 1 is opened. Further, FIG. 5 is a side view schematically showing a detachment restrained state of the base portion and the card reader by closing the open/close door. FIG. 6 is a perspective view showing the entire configuration of another slot machine.

The slot machine 1 has a cabinet 10 and the open/close door 11 at a position on the slightly upper side of the middle in the vertical direction of the cabinet 10. Further, as shown in FIG. 2, the slot machine 1 has a housing part S on the back side of an opening part P corresponding to the open/close door 11 inside the cabinet 10, and a reel unit 5 (a gaming unit in the present invention) is incorporated in the housing part S. The reel unit 5 comprises three mechanical reels 3L, 3C, and 3R arranged side by side in a line to be rotatable, on each of which symbols are drawn.

The open/close door 11 has a later-described liquid crystal display device 12 and a frame-shaped body 13 formed to support the periphery of the liquid crystal display device 12 from the outside, and is formed in a rectangular shape as a whole capable of closing the opening part P of the housing part S as shown in FIG. 2. The open/close door 11 has three vertically long window parts 10L, 10C, and 10R at a substantially middle part thereof so that the reels 3L, 3C, and 3R can be viewed from the outside through the respective window parts 10L, 10C, and 10R.

In addition, the open/close door 11 is placed in an upward slant form such that it falls backward on the upper side and thus rises from a front side to a rear side to allow the reels 3L, 3C, and 3R to be easily viewed by a player while sitting. Furthermore, the open/close door 11 is configured to open/close in a specific direction, and its left end portion as seen from the front is a fixed end portion 11c fixed to the cabinet 10 and its other end portions are free end portions 11d, 11d and 11d which are not fixed to the cabinet 10 (see FIG. 1). The open/close door 11 is configured to open/close in the width direction (the right-left direction) by means of a not-shown hinge mechanism with the fixed end portion 11c as an axis, so as to form a closed state shown in FIG. 1 and an open state shown in FIG. 2.

The slot machine 1 further has a base portion 15 having a slant face gentler than the open/close door 11 below the open/close door 11. The base portion 15, on which various kinds of operation parts such as various kinds of game operation buttons 16 such as a BET button, a reel rotation button, a reel stop button, and so on and a slot 17 into which coins are thrown are arranged where the player performs operation required for playing games, forms an operation unit in the present invention and has a configuration integrally attachable to/detachable from the cabinet 10.

Further, the cabinet 10 is provided with an armrest 20 including a flat surface extending in a substantially horizontal direction on the front side of the base portion 15. Provision of the armrest 20 allows the player in operating the various kinds of operation members on the base portion 15 while sitting on a not-shown chair or the like to perform operation with his or her arms and wrists rested thereon.

Further, the cabinet 10 comprises two side-panel portions 21 vertically standing from the bottom portion on the rear side of the open/close door 11. Besides, above the open/close door 11 and between the side-panel portions 21, provided are, for example, a payout table 22 displaying information on games such as combinations of prize symbols and payout amount, and speakers 25L and 25R which generate effective performance sound to increase amusement in game during play of a game, and so on.

On the other hand, the slot machine 1 has a card reader 30. The card reader 30, which is one of the operation units in the present invention, is placed above the open/close door 11 and has a configuration integrally attachable to/detachable from the cabinet 10. The card reader 30 has a card insertion port 30a as an operation part where the player performs insertion operation of a not-shown card which stores information required for playing a game, and is configured to read the information recorded on the card inserted through the card insertion port 30a.

Further, the slot machine 1 has the transmissive liquid crystal display device 12 as a device for increasing the amusement in games. The liquid crystal display device 12 is provided on the open/close door 11. The liquid crystal display device 12 comprises a protective glass, a display plate, a liquid crystal panel, a light guide plate, a reflective film, and a fluorescent lamp, to perform transmissive display within a region corresponding to the window parts 10L, 10C, and 10R so that the reels 3L, 3C, and 3R can be viewed. For example, the liquid crystal display device 12 displays various kinds of moving performance images, information required for the player to carry on the game, and so on in accordance with the game. The frame-shaped body 13 for supporting the liquid crystal display device 12 is composed of a table carrier package (TCP) loaded with an IC for driving the liquid crystal panel and so on.

As described above, the slot machine 1 has the base portion 15 provided with a plurality of operation parts and the card reader 30, the base portion 15 and the card reader 30 being placed at positions where they can abut on the free end portions 11d and 11d of the open/close door 11 opposite each other, that is, placed at positions facing each other across the housing part S to face each other across the open/close door 11. Placement of the base portion 15 and the card reader 30 at such positions prevents them from hindering the open/close door 11 in opening/closing. The structures of the open/close door 11, the base portion 15, and the card reader 30 will be described in detail below.

The open/close door 11 has, as shown in FIG. 2, arresting portions 11a and 11b at backside portions of the free end portions 11d and 11d which are opposite each other.

On the other hand, the base portion 15 has, on the open/close door 11 side as shown in FIG. 3, a projecting end portion 15a projecting in a band shape long in the width direction and in a manner to be in contact with the arresting portion 11a. Further, the base portion 15 has, on the armrest 20 side as shown in FIG. 5, an engagement protrusion 15b having an L-shaped cross section long in the width direction.

Besides, the card reader 30 has, as shown in FIG. 3, such an entire shape as to correspond to a fit-in recess 50 ensured between the open/close door 11 and the payout table 22 in the cabinet 10. The card reader 30 further has, at a lower portion of a front panel 30d, a projecting end portion 30b projecting in a band shape long in the width direction and in a manner to be in contact with the arresting portion 11b. Further, the card reader 30 has, on the upper face as shown in FIG. 5, an arresting protrusion 30c in a band shape long in the width direction.

The base portion 15 and the card reader 30 having the above-described configurations are attachable to/detachable from the cabinet 10 without using a fixing means such as a screw or the like and, in addition, their detachment from the cabinet 10 is restrained only by the open/close door 11. This point will be described below.

The base portion 15 has the engagement protrusion 15b and the projecting end portion 15a at positions opposite each other. The engagement protrusion 15b is designed, as shown in FIG. 5, to be able to latch on from the lower side a protruding piece 40 formed on the side face of the armrest 20 on the base portion 15 side. When the engagement protrusion 15b is latched on the protruding piece 40, the engagement protrusion 15b engages with the protruding piece 40, so that the base portion 15 cannot be raised upward any further (in a B-direction shown in FIG. 5). Besides, the projecting end portion 15a has a structure projecting in a band shape in a manner to be in contact with the arresting portion 11a, and thus projects toward the housing part S side. Therefore, when the open/close door 11 closes the housing part S as shown in FIG. 5, the arresting portion 11a overlies the projecting end portion 15a from the above. Consequently, closing the housing part S by the open/close door 11 can retain the base portion 15.

The card reader 30 has the arresting protrusion 30c and the projecting end portion 30b. The arresting protrusion 30c is designed, as shown in FIG. 5, to be able to latch on from the inside of the fit-in recess 50 the cabinet 10. Besides, the projecting end portion 30b has a structure projecting in a band shape and thus projects toward the housing part S side. Therefore, when the open/close door 11 closes the housing part S as shown in FIG. 5, the arresting portion 11b overlies the projecting end portion 30b from the above. In addition, when the open/close door 11 closes the housing part S, the end portion of the open/close door 11 abuts on the front panel 30d of the card reader 30. Accordingly, closing the housing part S by the open/close door 11 can retain the card reader 30 and hold it in the fit-in recess 50 to prevent the card reader 30 from being pulled out frontward (an A-direction shown in FIG. 5).

As described above, the base portion 15 and the card reader 30 are latched on the armrest 20 and the cabinet 10 respectively, and then the housing part S is closed by the open/close door 11, resulting in a detachment restrained state in which the base portion 15 and the card reader 30 are installed in the cabinet 10 and cannot be detached as shown in FIG. 1.

On the other hand, when the open/close door 11 is turned in a specific direction (leftward in the present embodiment) from the closed state of the open/close door 11 to thereby open the open/close door 11 as shown in FIG. 2 and FIG. 4, the detachment restrained state by the open/close door 11 is released. Then, the base portion 15 and the card reader 30 can be detached from the cabinet 10 as shown in FIG. 3. In other words, the base portion 15 and the card reader 30 change between respective attachable/detachable states and unattachable/undetachable states, to/from the cabinet 10, in conjunction with the opening/closing operation of the open/close door 11. As a result, in the slot machine 1, by just performing the opening/closing operation of the open/close door 11 in the specific direction, the base portion 15 and the card reader 30 can be brought into the detachment restrained state, or the detachment restrained state can be released. The slot machine 1 has a structure that requires no troublesome operation such as loosening or tightening screws in attachment/detachment of the operation unit to/from the cabinet 10.

In addition, the base portion 15 and the card reader 30 are placed at positions capable of abutting on the free end portions 11d and 11d of the open/close door 11 opposite each other, and thus never hindering the open/close door 11 in opening/closing operation and never be hidden under the open/close door 11 even if the open/close door 11 is opened. Therefore, even when performing maintenance of the device housed in the cabinet 10 such as the reel unit 5 or the like, operation required for the maintenance of the various operation parts placed on the base portion 15 (for example, insertion or taking out of a card into/from the card reader 30, operation of the game operation buttons 16 during the maintenance of the various devices in the cabinet 10) is easily carried out, and visual check thereof during the maintenance can be performed without any trouble.

Further, by just performing the opening/closing operation of the open/close door 11 in the specific direction, the card reader 30 and the base portion 15 can change between their detachment restrained states and released states, leading to a reduction in the number of assembly steps and improvement in disassembly maintenance property in the slot machine 1. In other words, when the card reader 30 and the base portion 15 are disassembled for maintenance, it is not necessary to loosen the screws so as to remove the card reader 30 and the base portion 15 every time but only necessary to open the open/close door 11. Therefore, disassemble work of the slot machine 1 for maintenance is very simple. Further, closing the housing part S by the open/close door 11 can install the card reader 30 and the base portion 15 into the cabinet 10, resulting in a reduction in the number of steps such as tightening the screws and the like and good assembly property.

It is needless to say that the present invention is not limited to the above-described embodiment, but can be embodied in variously modified ways within a scope without departing from the gist. For example, in the above-described embodiment, the base portion 15 and the card reader 30 are placed above and below the open/close door 11 so that the open/close door 11 is opened/closed in the right-left direction. However, it is also adoptable that the base portion 15 and the card reader 30 are placed on the right and left of the open/close door 11 so that the open/close door 11 is opened/closed in a top-bottom direction.

Further, the open/close door 11 is configured to open/close by turning of the hinge mechanism, but may be configured, as shown in FIG. 6, to be long in the width direction so that the open/close door 11 is slid to the right and left by a guide means such as guide rails 41 and 42 which recess-projection fit each other (the guide rail 41 being in a recessed shape and the guide rail 42 being in a projecting shape) to be opened/closed. In this case, the base portion 15 and the card reader 30 will be placed in a direction crossing a direction in which the open/close door 11 is slid (an F-direction in the drawing).

Besides, it is adoptable to employ, as the operation unit, an input device such as a touch panel (a liquid crystal device) or the like in addition to the base portion 15, the card reader 30, and so on.

### Second Embodiment

Next, a slot machine according to a second embodiment will be described. Note that the following description will be presented mainly on points different from the slot machine according to the first embodiment, and description on common points will be omitted or simplified.

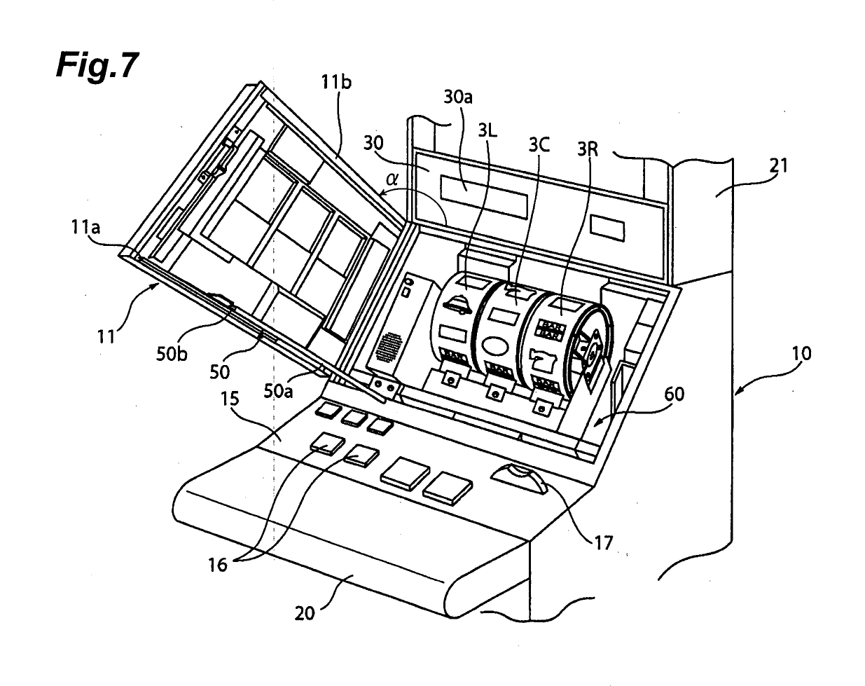

The slot machine according to the present embodiment is provided with, as shown in FIG. 7, a gas spring 50 between an open/close door 11 and a cabinet. The gas spring 50 is a support means capable of keeping the open state of the open/close door 11, and has a cylinder 50a forming a gas chamber and a piston 50b inserted in the cylinder 50a in a manner to freely advance and retract and operate by a gas pressure. Further, an end portion of the cylinder 50a is pivotally attached to the cabinet 10 side, and a tip portion of the piston 50b is pivotally attached to a rear face of the open/close door 11.

Further, in the slot machine according to the present embodiment, a base portion 15 and a card reader 30 have attachable/detachable configurations as in the slot machine according to the first embodiment, so that they can be detached from the cabinet 10. However, the slot machine according to the present embodiment, different from the slot machine 1 according to the first embodiment, has a positioning means for positioning with respect to the cabinet 10 the base portion 15 which is attachable to/detachable from the cabinet 10. In the slot machine according to the present embodiment, the positioning means is composed of later-described positioning pins 60 and 62 and pin holes 74 and 76.

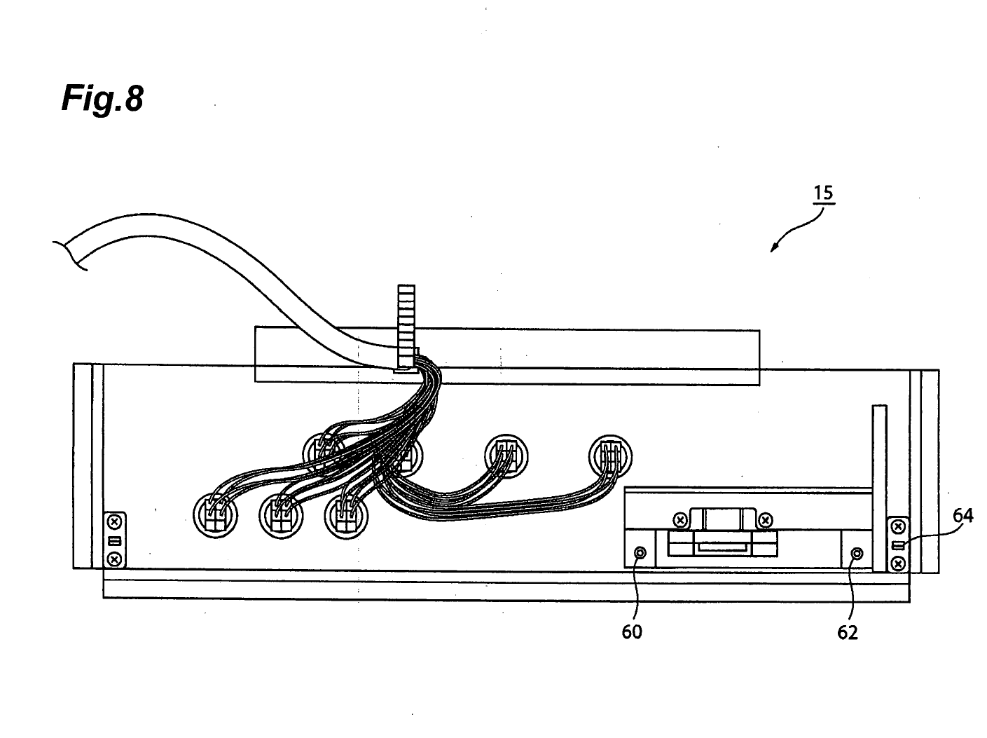

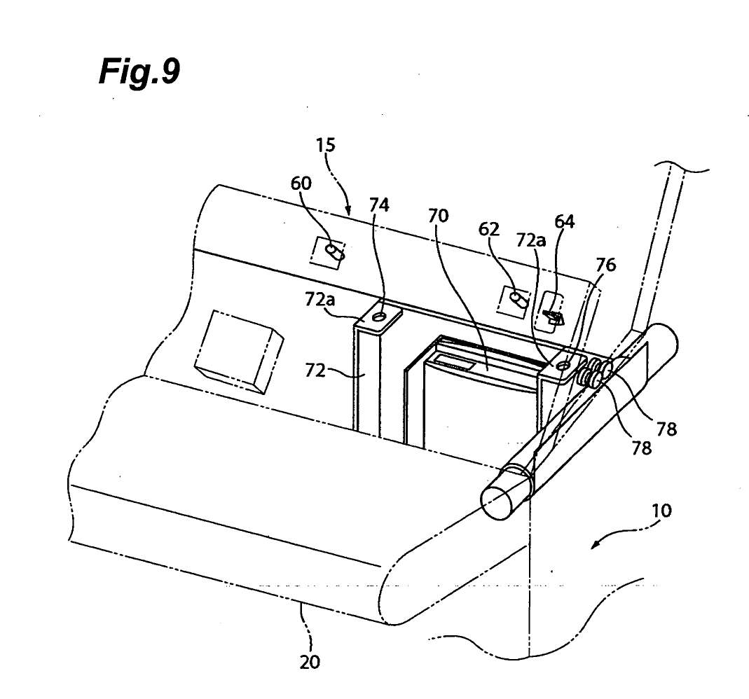

The positioning pins 60 and 62, which are projection-shaped structure portions in the present invention, have a projecting-shape structure projecting in a rod shape from a rear face of the base portion 15 (a face opposing the cabinet 10 when they are attached to the cabinet 10) as shown in FIG. 8 and FIG. 9, and are arranged with an appropriate interval therebetween. Further, an engagement protrusion 64 is formed near the positioning pin 62.

On the other hand, the pin holes 74 and 76, which are recess-shape structure portions in the present invention, have a recess-shape structure sized to allow the positioning pins 60 and 62 to be inserted thereinto, and are formed in a pair of brackets 72a and 72a. The pair of brackets 72a and 72a have the pine holes 74 and 76 with an arrangement interval corresponding to the arrangement interval of the positioning pins 60 and 62, and are formed at open side end portions of frame-shaped bodies 72 shown in FIG. 9. Besides, the frame-shaped bodies 72 have a structure capable of capturing a back side portion and a side face portion of a coin selector 70 housed in the cabinet 10, and are formed with the pair of brackets 72a and 72a on the front side. Further, a pair of rollers 78 and 78 capable of elastically holding the engagement protrusion 64 therebetween are provided near the bracket 72a at an end portion of the cabinet 10.

Since the above-described positioning pins 60 and 62 have a projection-shaped structure and the pin holes 74 and 76 have a recess-shaped structure, the positioning pins 60 and 62 and the pin holes 74 and 76 can recess-projection fit each other. Therefore, when the base portion 15 is attached to the cabinet 10, the base portion 15 is positioned with respect to the cabinet 10. In other words, the base portion 15 can be attached to the cabinet 10 such that the positioning pins 60 and 62 fit in the pin holes 74 and 76, so that the positions of the positioning pins 60 and 62 with respect to the pin holes 74 and 76 are fixed, whereby the position of the base portion 15 with respect to the cabinet 10 is fixed. This eliminates troublesome positional adjustment when attaching the base portion 15 to the cabinet 10, leading to simplified assembly work. Further, since the pin holes 74 and 76 in the recess-shaped structure provided on the cabinet 10 side and the positioning pins 60 and 62 in the recess-shaped structure provided on the base portion 15 side constitute the positioning means, the base portion 15 can be accurately reattached to the cabinet 10 by such a simple configuration.

Note that the above-described positioning means has a recess-projection fittable configuration. The positioning means in the present invention, however, may have a structure other than the recess-projection fittable configuration. It is also adoptable to provide a recess-shaped structure portion on the base portion 15 side and a projection-shaped structure on the cabinet 10 side. It is also adoptable to provide a recess-shaped structure portion or a projection-shaped structure portion on the card reader 30 and a projection-shaped structure portion or a recess-shaped structure portion on the cabinet 10.

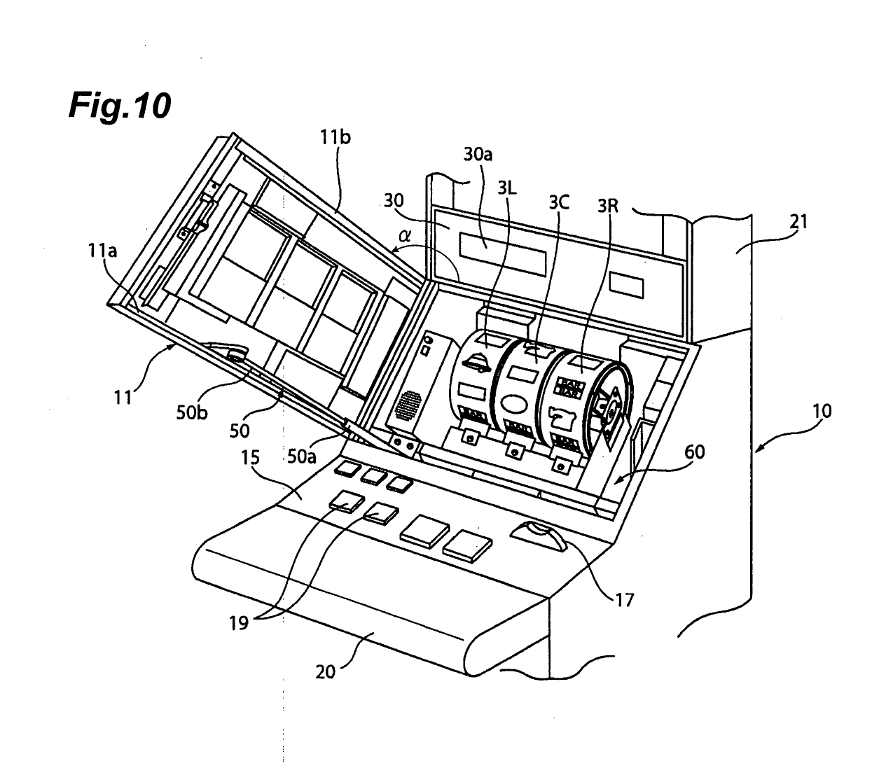

Furthermore, in the slot machine according to the present embodiment, an open angle α from the closed state of the open/close door 11 can be set at 90 degrees or more as show in FIG. 7 and FIG. 10, so that the open/close door 11 can be opened to 90 degrees or more. Therefore, the open/close door 11 of the slot machine according to the present embodiment can be opened enough to ensure a large work space which can be used for a maintenance work of the card reader 30 and the base portion 15. Accordingly, the maintenance work can be performed on the slot machine according to the present embodiment. If the open/close door 11 is opend enough, the card reader 30 and the base portion 15 never be hidden by the open/close door 11.

Further, the slot machine according to the present embodiment has the gas spring 50 so that the open/close door 11 can be openably/closably supported by the gas spring 50. Therefore, the open state of the open/close door 11 can be maintained with the open/close door 11 kept opened at 90 degrees or more from the closed state, thus preventing a situation that the open/close door 11 is suddenly closed during the maintenance work. Moreover, it is also possible to design such that the weight of the open/close door 11 does not always act on the gas spring 50 when the open/close door 11 is opened to almost 90 degrees from the closed state as shown in FIG. 10. Consequently, in the slot machine according to the present embodiment, early deterioration of the gas spring 50 can be prevented, and even if the gas spring 50 is deteriorated, sudden closing of the open/close door 11 can be prevented.

In addition to the slot machine as illustrated in the previously described embodiments, the present invention is applicable to various gaming machines comprising devices on both sides of the open/close door such as a pachinko (pinball) machine and so on. Note that an elastic member comprising a mechanical spring or an air-pressure spring is able to use as the support means.

It is apparent that various embodiments and modifications of the present invention can be embodied, based on the above description. Accordingly, it is possible to carry out the present invention in the other modes than the above best mode, within the following scope of claims and the scope of equivalents.

1. A gaming machine comprising a cabinet, a gaming unit required for playing a game housed in said cabinet, an open/close door capable of closing a housing part for said gaming unit in said cabinet, and operation units each including an operation part where a player performs operation required for playing the game,
wherein said open/close door is formed in a shape having a fixed end portion fixed to said cabinet and a plurality of free end portions not fixed to said cabinet, and
wherein said operation units are placed at positions where said operation units are capable of abutting on the free end portions of said open/close door.

2. The gaming machine according to claim 1, wherein said operation units are placed at positions opposite each other across said housing part.

3. The gaming machine according to claim 1, wherein said operation unit has a projecting end portion capable of coming into contact with a backside of the free end portion of said open/close door so that when said open/close door closes said housing part, the backside of the free end portion of said open/close door overlies the projecting end portion.

4. The gaming machine according to claim 1,
wherein said operation units have a configuration attachable to/detachable from said cabinet,
said machine further comprising a positioning means for positioning said operation units with respect to said cabinet.

5. The gaming machine according to claim 4, wherein said positioning means is composed of a projection-shaped structure portion provided on any one of said operation unit and said cabinet and a recess-shaped structure portion provided on the other capable of recess-projection fitting over the projection-shaped structure portion.

6. The gaming machine according to claim 1, further comprising a configuration that an open angle of said open/close door from a closed state thereof is settable to 90 degrees or more.

7. The gaming machine according to claim 1, further comprising a support means for openably/closably maintaining an open state of said open/close door.

8. A gaming machine comprising a cabinet, a gaming unit required for playing a game housed in said cabinet, a rectangular open/close door capable of closing a housing part for said gaming unit in said cabinet, and a plurality of operation units each including an operation part where a player performs operation required for playing the game,
wherein said operation units are placed at positions opposite each other along a direction crossing a direction of movement of said open/close door and where said operation units are capable of abutting on any of the end portions of said open/close door.
